(19) United States
(12) Patent Application Publication
(10) Pub. No.: US 2004/0217940 A1
(43) Pub. Date: Nov. 4, 2004

(54) Method of Displaying Items in an On Screen Display

(76) Inventor: Chi-Pao Huang, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,677

(22) Filed: Apr. 29, 2003

(51) Int. Cl. G09G 5/08

(52) U.S. Cl. 345/157

(57) ABSTRACT

A method for displaying items in an on screen display (OSD). The method includes displaying items in a current menu in response to input from a menu selection key, the current menu having at least a first item; enabling placing of a cursor on the first item in the current menu; displaying each item in a child menu corresponding to the first item for a predetermined period of time in a sequential manner, and simultaneously displaying items in the current menu not containing the cursor, the child menu having at least a second item; enabling choosing of the second item of the child menu with input from the menu selection key, the child menu corresponding to the chosen item becoming the current menu; and repeating the above steps until a desired menu item is chosen.

### BACKGROUND OF INVENTION

1. Field of the Invention

The present invention relates to an on screen display (OSD), and more specifically, to a method of displaying items of a menu and a child menu on a single form of the OSD.

2. Description of the Prior Art

On screen displays (OSDs) are commonly used for providing a convenient interface for users to program or configure an electronic device. Many electronic devices that contain a display or that can be connected to a device with a display can utilize an OSD. For example, OSDs are frequently found in computer monitors, televisions, VCRs, etc.

Please refer to FIG. 1. FIG. 1 is a diagram of a monitor 10 using an OSD according to the prior art. Please note that the monitor 10 is used as an example, and any kind of display device containing an OSD can be used. The monitor 10 contains a housing 12, a display screen 14, and a plurality of input keys 15. The input keys 15 include a menu selection key 16 for opening the OSD and for making selections within the OSD, two directional keys 18, 20 for moving a cursor left or right, and an exit key 22 for exiting from the OSD.

Please refer to FIG. 2. FIG. 2 is a diagram of an OSD containing two forms for displaying a current menu 30 and a child menu 40. Ikezaki teaches this OSD containing two forms in U.S. Pat. No. 5,367,316 entitled “Remote-control apparatus for electronics apparatus”, which is herein incorporated by reference. The display screen 14 is shown in FIG. 2 as containing the current menu 30 and the child menu 40, each menu located on a different form. The current menu 30 contains a first item 32, second item 34, third item 36, and fourth item 38. A cursor 35 is used to select one of the items in the current menu 30, and the cursor 35 can be moved through the use of the directional keys 18, 20 on the monitor 10.

As shown in FIG. 2, the cursor 35 points to the second item 34 in the current menu 30. Since the cursor 35 is pointing to the second item 34, the child menu 40 contains items in a subfolder corresponding to the second item 34. The child menu 40 contains a label 42, which indicates the particular item in the current menu 30 that the child menu 40 corresponds to. The child menu 40 is displayed for convenience for allowing the user to quickly see subfolder items corresponding to the item in the current menu 30 that has been selected by the cursor 35. In this way, the user can see the child menu 40 by moving the cursor 35 to the second item 34, and the menu selection key 16 does not have to be pressed in order to view the child menu 40.

Unfortunately, the prior art OSD requires both the current menu 30 and the child menu 40 to be used for showing the contents of subfolder items corresponding to an item in the current menu 30. In addition, the user needs to check all subfolders in order to locate the item he wants to adjust.

### SUMMARY OF INVENTION

It is therefore a primary objective of the claimed invention to provide a method for displaying items in an on screen display (OSD) in order to solve the above-mentioned problems.

According to the claimed invention, a method for displaying items in an on screen display (OSD) is disclosed. The method comprises displaying items in a current menu in response to input from a menu selection key, the current menu having at least a first item; enabling placing of a cursor on the first item in the current menu; displaying each item in a child menu corresponding to the first item for a predetermined period of time in a sequential manner, and simultaneously displaying items in the current menu not containing the cursor, the child menu having at least a second item; enabling choosing of the second item of the child menu with input from the menu selection key, the child menu corresponding to the chosen item becoming the current menu; and repeating the above steps until a desired menu item is chosen.

The method further comprises moving the cursor among the displayed items according to input from a directional key and displaying on a single form of the OSD the items in the child menu corresponding to the first item and the items in the current menu not containing the cursor. If the first item does not have a corresponding child menu, the menu comprises displaying the first item and simultaneously displaying items in the current menu not containing the cursor. If an exit key is pressed while a top-level menu is not shown, the method comprises displaying items of the top-level menu. On the other hand, if the exit key is pressed while the top-level menu is being displayed, the method comprises exiting the OSD. Each menu item can be displayed as an icon containing a pictographic or textual description of a function of the menu item.

According to the claimed invention, a display device containing an OSD is disclosed. The display device comprises a display screen for displaying items in a current menu of an OSD; a control circuit for placing a cursor on one of the items in the current menu; a timer circuit for displaying each item in a child menu corresponding to the item of the current menu containing the cursor for a predetermined period of time in a sequential manner while simultaneously displaying items in the current menu not containing the cursor; and a menu selection key for choosing one of the displayed items, a child menu corresponding to the chosen item becoming the current menu.

The display device contains a directional key for moving the cursor among the displayed items. The OSD makes use of a single form for displaying the items in the child menu corresponding to the item of the current menu containing the cursor and the items in the current menu not containing the cursor. If the item of the current menu containing the cursor does not have a corresponding child menu, single form displays the item of the current menu containing the cursor and simultaneously displaying items in the current menu not containing the cursor.

The display device contains an exit key for instructing the control circuit to display items from a top-level menu of the OSD if the OSD is not already displaying the top-level menu. If the OSD is displaying the top-level menu when the exit key is pressed, the OSD is exited. Each menu item can be displayed as an icon containing a pictographic or textual description of a function of the menu item.

It is an advantage of the claimed invention that the present invention method can display both current menu items and child menu items in a single form of the OSD. This simplifies the OSD interface and requires less space to be used for showing the OSD.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a monitor using an OSD according to the prior art.

FIG. 2 is a diagram of an OSD containing two forms for displaying a current menu and a child menu.

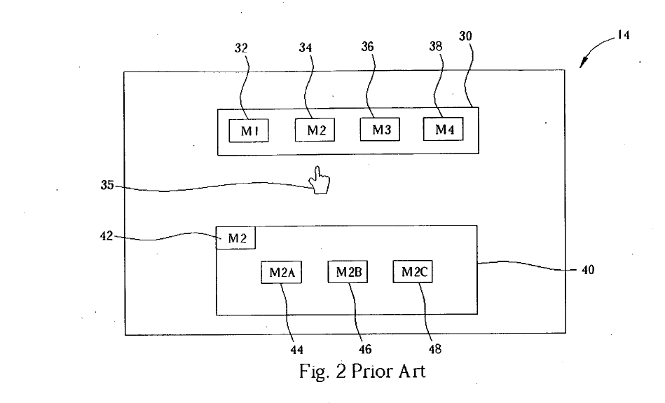

FIG. 3 is a tree structure illustrating an OSD according to the present invention.

FIG. 4 is a functional block diagram of the monitor shown in FIG. 1 according to the present invention.

FIG. 5 is a state diagram showing operation of the OSD according to the present invention.

### DETAILED DESCRIPTION

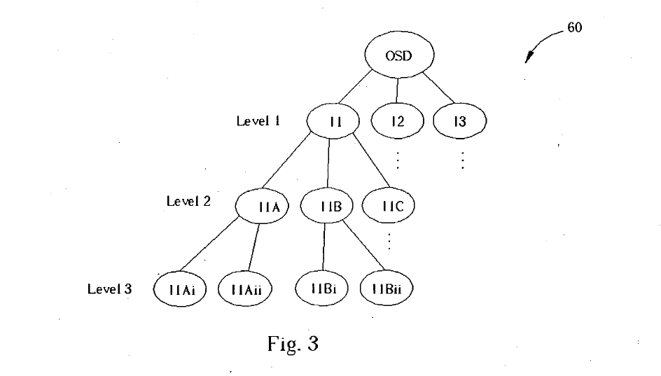

Please refer to FIG. 3. FIG. 3 is a tree structure 60 illustrating an OSD according to the present invention. The OSD shown in the tree structure 60 contains three levels. Level 1 is a menu containing three items 11, 12, and 13. Each of these three items 11, 12, and 13 contains corresponding child menus. Only the child menu for item 11 is shown for simplicity. The child menu for item 11 contains items 11 A, 11 B, and 11 C. Each of these three items 11 A, 11 B, and 11 C may contain a child menu, but only the child menus for items 11 A and 11 B are shown. The child menu for item 11 A contains items 11 Ai and 11 Aii, whereas the child menu for item 11 B contains items 11 Bi and 11 Bii.

The following will describe use of the terms in current menu, child menu, and top-level menu for this disclosure. In this embodiment, the items in the current menu are items 11 A, 11 B, and 11 C, all shown in Level 2 of the tree structure 60. With respect to the current menu, the top-level menu would contain items 11, 12, and 13, all shown in Level 1 of the tree structure 60. A child menu for item 11 B contains items 11 Bi and 11 Bii, all shown in Level 3 of the tree structure 60.

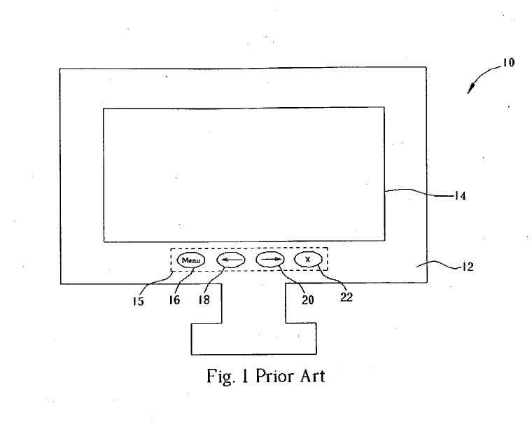

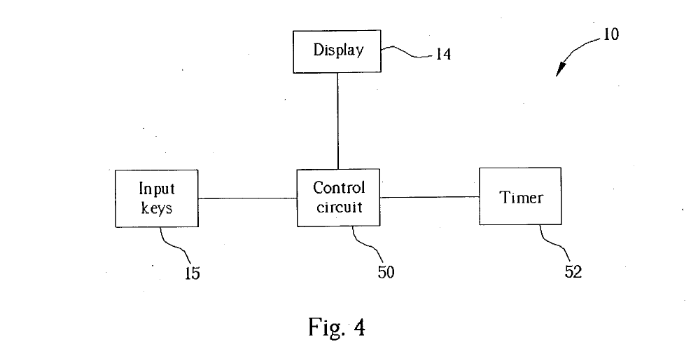

Please refer to FIG. 4. FIG. 4 is a functional block diagram of the monitor 10 according to the present invention. A basic structure of the prior art monitor 10 shown in FIG. 1 is also used in the present invention monitor 10, and same reference numbers will be used to refer to identical parts. Like the monitor 10 shown in FIG. 1, the present invention monitor 10 also contains the display screen 14 and the input keys 15. In addition, the monitor 10 contains a control circuit 50 for controlling operation of the monitor 10 and for placing a cursor on the display screen 14. A timer circuit 52 is used for providing timing information to the control circuit 50. As will be shown below, the display screen 14 will be continuously refreshed after a predetermined period of time, such as every T seconds.

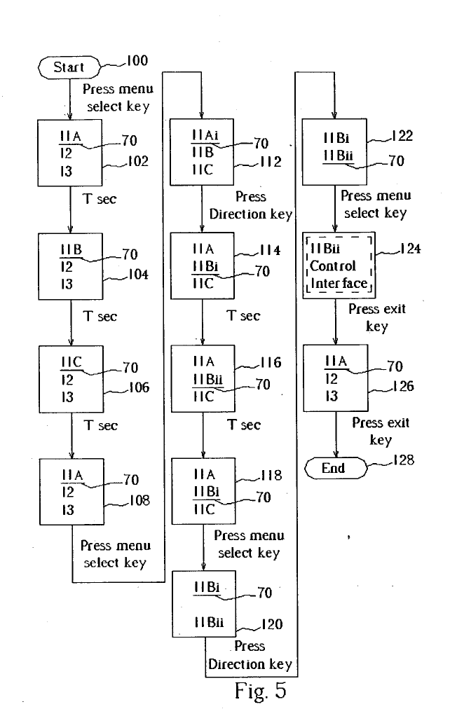

Please refer to FIG. 5. FIG. 5 is a state diagram showing operation of the OSD according to the present invention. A cursor 70 is used for choosing one of the items in the current menu. The control circuit 50 treats the item containing the cursor differently than the items in the current menu not containing the cursor 70. Instead of displaying the item in the current menu containing the cursor 70, each of the items in the child menu is sequentially displayed for T seconds. After each T seconds, the display screen 14 is refreshed, with a next item in the child menu being displayed. During this time, the items in the current menu not containing the cursor 70 are constantly displayed on the display screen 14. In this manner, the items in the current menu and the child menu can be displayed on a single form. Steps contained in the state diagram will be explained below.

Step 100: Start;

Step 102: The menu selection key 16 was pressed, thereby entering the OSD and displaying a top level of the OSD shown in Level 1 of the tree structure 60. The current menu contains items 11, 12, and 13. Item 11 is chosen by default to contain the cursor 70 and a first item 11 A in a first child menu of item 11 is displayed for T seconds in place of item 11. Items 12 and 13 of the current menu are constantly displayed;

Step 104: T seconds have elapsed, causing the display screen 14 to be refreshed. A second item 11 B in the first child menu of item 11 is now displayed for T seconds in place of item 11. Meanwhile, items 12 and 13 of the current menu are constantly displayed;

Step 106: T seconds have elapsed, causing the display screen 14 to be refreshed. A third item 11 C in the first child menu of item 11 is now displayed for T seconds in place of item 11. Meanwhile, items 12 and 13 of the current menu are constantly displayed;

Step 108: T seconds have elapsed, causing the display screen 14 to be refreshed. Since there are only three items in the first child menu of item 11, the first item 11 A in the first child menu of item 11 is now displayed again for up to T seconds in place of item 11. Meanwhile, items 12 and 13 of the current menu are constantly displayed;

Step 112: The menu selection key 16 was pressed, thereby making the first child menu of item 11 the current menu. The current menu contains items 11 A, 11 B, and 11 C. Item 11 A is chosen by default to contain the cursor 70 and a first item 11 Ai in a second child menu of item 11 A is displayed for up to T seconds in place of item 11 A. Items 11 B and 11 C of the current menu are constantly displayed;

Step 114: One of the directional keys 18, 20 was pressed, thereby moving the cursor 70 from item 11 A to item 11 B. A first item 11 Bi in a third child menu of item 11 B is displayed for T seconds in place of item 11 B. Items 11 A and 11 C of the current menu are constantly displayed;

Step 116: T seconds have elapsed, causing the display screen 14 to be refreshed. A second item 11 Bii in the third child menu of item 11 B is now displayed for T seconds in place of item 11 B. Meanwhile, items 11 A and 11 C of the current menu are constantly displayed;

Step 118: T seconds have elapsed, causing the display screen 14 to be refreshed. Since there are only two items in the third child menu of item 11 B, the first item 11 Bi in the third child menu of item 11 B is now displayed again for up to T seconds in place of item 11 B. Meanwhile, items 11 A and 11 C of the current menu are constantly displayed;

Step 120: The menu selection key 16 was pressed, thereby making the third child menu of item 11 B the current menu. The current menu contains items 11 Bi and 11 Bii. Item 11 Bi is chosen by default to contain the cursor 70. Since item 11 Bi does not contain a child menu, item 11 Bi is constantly displayed, along with item 11 Bii;

Step 122: One of the directional keys 18, 20 was pressed, thereby moving the cursor 70 from item 11 Bi to item 11 Bii;

Step 124: The menu selection key 16 was pressed, allowing the user to enter the 11 Bii control interface. Through this interface, adjustments can be made to the function represented by 11 Bii;

Step 126: The exit key 22 was pressed, causing the OSD to display a top-level menu shown in Level 1 of the tree structure 60. When the OSD displays a menu other than the top-level menu, pressing the exit key 22 causes the OSD to go back to the top-level menu; and

Step 128: The exit key 22 was pressed again while the OSD was displaying the top-level menu, therefore the OSD is exited.

Each of the items in the OSD menu of the present invention can be displayed as icons in the OSD. The icons can contain a pictograph representation of the function to be performed, a textual representation, or contain both a pictograph and textual representation.

Compared to the prior art method of displaying items in an OSD, the present invention can display both current menu items and child menu items in a single form of the OSD. By moving the cursor among different items in the current menu, the item in the current menu containing the cursor can be replaced by items in its child menu in a sequential manner. Using only one form in the OSD simplifies the OSD interface, thereby requiring less space to be used for showing the OSD.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of displaying items in an on screen display (OSD), the method comprising:
(a) displaying items in a current menu in response to input from a menu selection key, the current menu having at least a first item;
(b) enabling placing of a cursor on the first item in the current menu;
(c) displaying each item in a child menu corresponding to the first item for a predetermined period of time in a sequential manner, and simultaneously displaying items in the current menu not containing the cursor, the child menu having at least a second item;
(d) enabling choosing of the second item of the child menu with input from the menu selection key, the child menu corresponding to the chosen item becoming the current menu; and
(e) providing repetition of steps (a) through (d) until a desired menu item is chosen.

2. The method of claim 1 wherein step (b) further comprises a step (b2) of moving the cursor among the displayed items according to input from a directional key.

3. The method of claim 1 wherein step (c) further comprises a step (c2) of displaying on a single form of the OSD the items in the child menu corresponding to the first item and the items in the current menu not containing the cursor.

4. The method of claim 1 wherein step (c) further comprises a step of displaying the first item and simultaneously displaying items in the current menu not containing the cursor if the first item does not have a corresponding child menu.

5. The method of claim 1 further comprising a step (f) of displaying items of a top-level menu in response to input from an exit key.

6. The method of claim 5 further comprising a step (g) of exiting the OSD in response to input from the exit key when the items from the top-level menu are being displayed.

7. The method of claim 1 wherein each menu item is displayed as an icon containing a pictographic representation of a function of the menu item.

8. The method of claim 1 wherein each menu item is displayed as an icon containing a textual description of a function of the menu item.

9. A display device containing an on screen display (OSD), the display device comprising:
a display screen for displaying items in a current menu of an OSD;
a control circuit for placing a cursor on one of the items in the current menu;
a timer circuit for displaying each item in a child menu corresponding to the item of the current menu containing the cursor for a predetermined period of time in a sequential manner while simultaneously displaying items in the current menu not containing the cursor; and
a menu selection key for choosing one of the displayed items, a child menu corresponding to the chosen item becoming the current menu.

10. The display device of claim 9 further comprising a directional key for moving the cursor among the displayed items.

11. The display device of claim 9 wherein the OSD contains a single form for displaying the items in the child menu corresponding to the item of the current menu containing the cursor and the items in the current menu not containing the cursor.

12. The display device of claim 9 wherein the OSD contains a single form for displaying the item of the current menu containing the cursor and simultaneously displaying items in the current menu not containing the cursor if the item of the current menu containing the cursor does not have a corresponding child menu.

13. The display device of claim 9 further comprising an exit key for instructing the control circuit to display items from a top-level menu of the OSD.

14. The display device of claim 13 wherein pressing the exit key when the items from the top-level menu are being displayed exits the OSD.

15. The display device of claim 9 wherein each menu item is displayed as an icon containing a pictographic representation of a function of the menu item.

16. The display device of claim 9 wherein each menu item is displayed as an icon containing a textual description of a function of the menu item.
